(19) United States
(12) Patent Application Publication
(10) Pub. No.: US 2025/0033168 A1
(43) Pub. Date: Jan. 30, 2025

(54) QUICK CLAMPING DEVICE WITH SENSOR ARRANGEMENT AND USE THEREOF

(71) Applicant: GTS Deutschland GmbH, Ditzingen (DE)

(72) Inventors: Marco Brunner, Horgen (CH); Robert Schulze, Erfurt (DE); Kai Schicker, Rosenbach (DE)

(73) Assignee: GTS Deutschland GmbH, Ditzingen (DE)

(21) Appl. No.: 18/913,871

(22) Filed: Oct. 11, 2024

Related U.S. Application Data
(63) Continuation of application No. PCT/EP2023/059584, filed on Apr. 12, 2023.

(30) Foreign Application Priority Data
Apr. 13, 2022 (DE) 20 2022 102 003.5

(51) Int. Cl. B25B 5/16; B61L 23/04

(52) U.S. Cl. CPC B25B 5/16; B61L 23/04

(57) ABSTRACT

A quick clamping device for securing at least one rail-monitoring element on a rail includes two clamping units that each have two clamping brackets and one clamp. In each case the two clamping brackets are connectable at a first end by the clamp along a clamping axis, such that the clamp, when secured on the rail, engages under the rail foot of the rail. The clamping brackets each have, at a second end, a clamping region which is designed for force-locking arrangement on a rail web of the rail and/or on the rail-monitoring element. The clamping units, as separate elements, can be arranged on the rail to be mutually spaced along a longitudinal extent of the rail. The clamping brackets each have at least one curvature portion that is curved in a plane orthogonal with respect to the clamping axis.

### CROSS-REFERENCE TO RELATED APPLICATIONS

This continuation application claims priority to PCT/EP2023/059584 filed on Apr. 12, 2023 which has published as WO 2023/198794 A1 and also the German application number 20 2022 102 003.5 filed on Apr. 13, 2022, the entire contents of which are fully incorporated herein with these references.

### DESCRIPTION

### Field of the Invention

The invention relates to a quick clamping device for fastening at least one rail monitoring element to a rail, having two clamping units. The clamping units each have two clamping brackets and a clamping means. The two clamping brackets can each be connected at a first end by the clamping means along a clamping axis such that the clamping means engages under the rail foot of the rail when fastened to the rail. The clamping brackets at a second end each have a clamping region, which is designed for force-fit arrangement on a rail web of the rail and/or the rail monitoring element. The invention also relates to a sensor arrangement having the quick clamping device and to the use of the quick clamping device.

### Background of the Invention

Quick-clamping devices are used, for example, in railway systems to fasten rail monitoring elements to the rail without causing any damage. The rail monitoring element is clamped to the rail by the quick clamping device. This means that drilling into the rail to create a bolt fastening can be avoided, for example. Using the quick clamping device, the rail monitoring element can be permanently fastened, i.e., for the service life of the monitoring element, or only temporarily, e.g., until an adhesive between the rail and the monitoring element has cured.

Document [01] discloses a fastening device and a method for fastening at least one sensor to a railway rail. The fastening device has two clamping brackets and two crossbeam elements connecting the clamping brackets. The clamping brackets are foldably arranged on the crossbeam elements such that the fastening device can be pushed under a rail when the clamping brackets are folded in. The clamping brackets can then be folded out to fasten the sensor to the rail.

However, the clamping fastening devices known in the prior art are limited in terms of their possible applications to the rail. For example, they cannot be arranged on a rail tie, since conventional fastening devices would collide with the rail tie. Likewise, arranging them immediately next to a rail tie is difficult, because mounting space is required for tool access to the fastening device. This also means that the position of the sensor on the rail is limited by the fastening device. For example, a sensor cannot be fastened to the rail above a rail tie using conventional clamping fastening devices, because a conventional fastening device would collide with the rail tie.

The previously mentioned document, [01], discloses a further fastening device in which the clamping brackets are arranged on a common clamping means and extend away therefrom in a V-shape. However, such a design represents only an inadequate extension of the above-described possible use on the rail, since it is still not possible to fasten the sensor above a rail tie. In addition, the V-shaped arrangement of the clamping brackets significantly reduces the region between the clamping brackets for receiving the sensor to be fastened. This means that only sensors that are adapted to this reduced receiving region of the fastening device can be arranged on the rail using the fastening device. The sensor compatibility of said fastening device is therefore largely limited.

### SUMMARY OF THE INVENTION

### Object of the Invention

One object of the invention is to provide a quick clamping device which can be used on the rail in an improved manner and increases sensor compatibility. Furthermore, one object of the invention is to propose a sensor arrangement and a use of the quick clamping device.

### DESCRIPTION OF THE INVENTION

This object is achieved according to the invention by a quick clamping device of the type mentioned at the outset having the characterizing features according to the independent claim, by a sensor arrangement of the type mentioned at the outset having the characterizing features according to the claims, and the use of the quick clamping device having the characterizing features according to claims.

In other words, the object is achieved by a quick clamping device in which the clamping units can be arranged on the rail as separate elements at a distance from one another along a longitudinal extent of the rail; and in which the clamping brackets each have at least one curvature portion that is curved in a plane orthogonal to the clamping axis.

The quick clamping device according to the invention thus has several advantages over conventional quick clamping devices.

Firstly, the quick clamping device can be flexibly adapted to the dimensions of the rail monitoring element to be fastened, by changing the distance between the quick clamping units along the longitudinal extent of the rail. This increases the flexibility of the quick clamping device with regard to the rail monitoring element to be fastened.

In addition, the curvature portion formed on the clamping brackets enables the clamping regions to approach an “obstacle” located along the longitudinal extent of the rail, e.g., a rail tie, without reducing the tool's accessibility to the clamping means or a region for receiving the rail monitoring element between the clamping brackets.

Furthermore, the separate design of the clamping units keeps a gap free between the clamping units in the longitudinal direction of the rail, which gap can be positioned around a rail tie, for example. This allows for over-tie mounting.

The rail described according to the invention is preferably a railway rail. The rail preferably has a Vignole rail profile according to DIN EN 13674-1:2017-07, a rail profile according to the British standard, or a rail profile according to the Australian standard. The rail is a 60E1, a 49E1, a 54E3, a 54E1, an R65, or a BS80 rail, for example, with this in no way being an exhaustive list. In other words, the quick clamping device according to the invention is designed for use on all popular rail profiles.

When the quick clamping device is mounted on the rail, the clamping means engages under the rail foot of the rail. The rail foot is to be understood as the part of the rail that serves to support the rail. The rail head of the rail is to be understood as the part of the rail that is designed to guide the train wheels. The rail web is to be understood as the part of the rail that connects the rail foot and the rail head. Engaging under the rail foot is therefore to be understood to mean engaging behind the rail on the side opposite the rail head.

When the clamping unit is mounted on the rail, the clamping brackets of the clamping units each engage under the rail foot. Thus, each clamping unit engages under the rail foot when mounted.

Preferably, at least one, in particular, each, clamping unit rests on the rail foot. Together with the two clamping regions on the clamping brackets, this allows the clamping unit to be fixed particularly securely to the rail.

The clamping units can be arranged separately from each other on the rail or the rail monitoring element. In other words, the clamping units form a loose assembly. This allows the distance between the clamping axes of the clamping units to be adjusted depending upon the design of the rail monitoring element, in particular, the dimension of the rail monitoring element in the direction of the longitudinal extent of the rail.

Likewise, the dimension of the quick clamping device in a vertical direction can be adapted to a rail profile of the rail by rotating the clamping units about an axis perpendicular to the longitudinal extent of the rail. In other words, the height of the quick clamping device can be adjusted.

In addition, the quick clamping device can be manufactured more cost-effectively, since additional components, such as crossbeams for connecting the clamping units, may be dispensed with.

The clamping axis describes an axis of the clamping means along which the distance between the clamping brackets and thus the distance between the clamping regions of the clamping brackets of a clamping unit can be reduced. According to the invention, the clamping axis extends below the rail foot through the two clamping brackets of a clamping unit. In other words, the clamping axis extends underneath the rail foot of the rail. Preferably, the clamping axis extends transversely, in particular, at a right angle, to the longitudinal extent of the rail. In other words, the clamping axis extends at an angle with respect to the rail.

The curvature portion according to the invention preferably has a curvature axis that is parallel to the clamping axis. The clamping bracket is therefore curved in a plane projected in the direction of the clamping axis. The plane projected in the direction of the clamping axis corresponds to the installation space of the rail monitoring element. The curvature portion thus increases the region for receiving the rail monitoring element between the clamping units.

In a preferred embodiment of the rail monitoring element, the curvature portion is arcuate and at least has a radius of curvature of at least 10 millimeters, in particular, at least 15 millimeters, particularly preferably at least 25 millimeters, and at most 130 millimeters, in particular, at most 120 millimeters, particularly preferably at most 110 millimeters. This facilitates the increase in size of the receiving region between the clamping units while at the same time maintaining moderate mechanical loading in the clamping brackets during clamping of the clamping units. Preferably, the curvature portion has a plurality of different radii of curvature. This allows the receiving region to be enlarged with even greater precision when it comes to moderate loading.

Additionally preferred is an embodiment of the quick clamping device in which the clamping brackets of a clamping unit are symmetrical with respect to a plane orthogonal to the clamping axis. This makes it particularly easy to design the tool for one clamping bracket by mirroring the tool for the other clamping bracket, and changes can accordingly be made more quickly. This has a particularly positive effect on development costs.

Preferably, the clamping units of a quick clamping device are identical. In other words, both clamping units can be used in both positions provided for fastening the rail monitoring element. This makes it possible to reduce the costs of manufacturing tools for producing the clamping units as well as the unit costs of the components of the clamping units due to a higher proportion of identical parts.

In a preferred embodiment of the quick clamping device, the clamping means is designed as a bolted connection. For example, the clamping means can be designed as a push-in bolt, wherein a clamping bracket has a through-hole through which the clamping means can be pushed. The other clamping bracket can also have, for example, a recess with a thread into which the push-in bolt can be screwed.

Preferably, the clamping means is designed as a through-bolt assembly that passes through the two clamping brackets. In this case, the clamping means can have a nut at both ends to secure the bolted connection. This allows the clamping means to be designed to be particularly cost-effective and reliable.

In a particularly preferred embodiment, the clamping means passes through the two clamping brackets of a clamping unit, wherein the clamping means has a sliding body on which the clamping brackets are arranged, and wherein the clamping means has a bolt on each clamping bracket, which fastens the corresponding clamping bracket to the sliding body and is designed to set a maximum distance between the clamping brackets along the clamping axis. This allows the maximum distance between each of the clamping brackets and the sliding body to be adjusted, allowing the clamping units to be asymmetrically clamped.

The clamping means is preferably formed by a tool, in particular, an electrically and/or pneumatically operated tool, for clamping. Further preferably, the clamping means is formed by a tool for screwing in and unscrewing bolts and nuts for clamping. For example, the clamping means is formed by means of a pneumatic screwdriver and/or an electric screwdriver for clamping.

Further preferred is an embodiment of the quick clamping device in which the clamping brackets are made of a metallic material, in particular, aluminum and/or steel. A metallic material has high yield strengths, which results in greater load-bearing capacity of the clamping brackets. This can increase the fatigue strength and durability of the quick clamping device.

In a preferred embodiment of the quick clamping device, the clamping units have at least one insulating means which is designed to electrically insulate the quick clamping device from the rail. This can prevent any electrical charging of the clamping units and the associated disruption of the rail monitoring element to be fastened—for example, by influencing its magnetic field. Preferably, the insulating means is designed as an insulating sleeve.

Preferably, the insulating sleeve engages around at least a first end of one of the two clamping brackets and, when the quick clamping device is fastened to the rail, electrically insulates the quick clamping device from the rail foot. In other words, the clamping unit rests on the rail foot of the rail by means of the insulating means, while the clamping brackets are not in direct contact with the rail foot. This allows for particularly reliable electrical insulation.

Further preferably, the insulating sleeve engages around both first ends of both clamping brackets of a clamping unit when mounted. In other words, the insulating sleeve covers an intermediate region formed between the clamping brackets along the clamping axis. Particularly advantageously, the intermediate region between the first ends of the two clamping brackets of a clamping unit can be reliably protected from contamination by the insulating means, and the functionality of the clamping unit can be permanently maintained.

In a preferred embodiment of the quick clamping device, at least one, in particular, both, clamping brackets of a clamping unit has/have an electrical insulating means at the first and the second ends. This allows the clamping unit to be electrically insulated from both the rail foot and the rail web. Preferably, all insulating means are designed as insulating sleeves.

Further preferred is an embodiment of the quick clamping device in which the clamping units each have at least one clamping template, which is designed for positioning the clamping brackets on the rail web. The clamping template makes it easier to precisely position the clamping brackets and thus precisely position the rail monitoring element on the rail. Preferably, the clamping template is adapted and/or designed to be adaptable to the profile of the rail. This allows for even more precise positioning.

A preferred development of the quick clamping device provides that a clamping template be fastened or be able to be fastened to at least one, in particular, each, second end of a clamping bracket of a clamping unit in each case. This enables the clamping templates to be arranged in a particularly captive manner and facilitates rapid attachment of the quick clamping device to the rail.

Preferably, the clamping templates are designed to be attachable to the clamping region of the clamping brackets. This allows for faster changing of the clamping templates in the event of maintenance and/or faster adjustment of the quick clamping device to a specific profile of the rail.

Further preferably, both clamping brackets of a clamping unit are designed for arranging the at least one clamping template thereon. In other words, the clamping template can be arranged at the second end of one clamping bracket as well as at the second end of the other clamping bracket.

A development of the quick clamping device in which the clamping templates have at least one element which, in conjunction with the clamping bracket, form-lockingly limits, in particular, prevents, rotation of the clamping template relative to the clamping bracket, is also preferable. For example, a securing projection and/or a securing recess of the clamping template can engage in a complementary recess and/or a projection of the clamping bracket. This allows the relative position between the clamping template and the clamping bracket to be reliably predetermined, and the clamping units to be arranged on the rail even more easily.

Further preferred is a development of the quick clamping device in which at least one of the clamping templates is U-shaped in a cross-section parallel to the clamping axis. Preferably, the clamping template engages around the rail monitoring element when the quick clamping device is arranged on the rail.

The clamping template can be designed for arrangement between the rail foot and a rail head of the rail. Preferably, the clamping template can be designed for being clamped between the rail foot and the rail head. Particularly preferably, the clamping template is designed to only contact the rail foot and the rail head of the rail. In other words, when mounted on the rail, the clamping template is arranged without contact with the rail web. This allows the clamping brackets to be positioned particularly reliably without interfering with the region where the rail monitoring element is fastened to the rail.

Further preferred is a development of the quick clamping device in which the clamping template is designed to at least partially receive, in particular, fix, the rail monitoring element. This allows the rail monitoring element to be arranged particularly reliably on the clamping unit.

Preferably, the clamping templates have an electrically insulating material; in particular, the clamping templates consist of an electrically insulating material. For example, the clamping templates can be made of plastic, in particular, PA6, particularly preferably glass fiber-reinforced PA6. In this way, the clamping units can advantageously be electrically insulated from the rail by means of the clamping templates, and the strength of the clamping template can be increased.

In a particularly preferred embodiment, the clamping templates each have at least one, in particular, sleeve-like and/or metallic fastening insert, which is designed for arranging the clamping template on the clamping region of a clamping bracket. This allows the strength of the clamping template to be increased in certain regions, which further improves the durability of the clamping units.

The underlying object is also achieved by a sensor arrangement having a rail, a quick clamping device as described above, and a rail monitoring element mounted on a rail by means of the quick clamping device, wherein the rail web of the rail and the rail monitoring element are arranged at least partially between the clamping regions of the clamping brackets of two clamping units of the quick clamping device; wherein the clamping units each engage around the rail foot of the rail; and wherein, along a clamp axis running through the clamping regions, a clamping force is produced between the clamping unit, the rail monitoring element, and the rail web.

According to the sensor arrangement according to the invention, the rail monitoring element is thus pressed onto the rail web of the rail by means of the clamping units of the quick clamping device. As a result, the rail monitoring element can be permanently arranged on the rail without causing any damage and can be removed again if necessary.

A further advantage of the sensor arrangement according to the invention consists in that the distance between the clamping units of a quick clamping device can be adapted to the rail monitoring element to be fastened, such that rail monitoring elements of different dimensions can be fastened to the rail using the same quick clamping device.

Further advantageously, the gap between the clamping units of a quick clamping device is not blocked by additional components, such as crossbeams, whereby the sensor arrangement can be arranged such that, for example, a rail tie of the rail is arranged in the intermediate region between the two clamping units. In other words, the clamping units can be arranged next to the rail tie on either side in the longitudinal extent of the rail, whereby the rail monitoring element can be fastened to the rail web above the rail tie. This increases flexibility when positioning the rail monitoring element.

According to the invention, the two clamping regions of the clamping bracket lie on the clamp axis. The clamp axis runs transversely, in particular, at a right angle, to the longitudinal extent of the rail. Preferably, the clamp axis is parallel to the clamping axis.

Preferably, the clamping units of a quick clamping device have the same, in particular, identical clamping brackets. In other words, one clamping unit has the same clamping brackets as the other clamping unit. Particularly preferably, the quick clamping device has two identical clamping units.

The clamping brackets of one clamping unit can be arranged on the rail facing the other clamping unit and/or facing away therefrom. In other words, the curvature portions of the clamping brackets can be curved towards and/or away from one another.

In a particularly preferred embodiment of the sensor arrangement, the distance between the clamping axes is greater than a distance between the clamp axes of the clamping units, and a rail tie is arranged between the clamping units. In other words, the clamping brackets of the clamping units face away from one another, or the curvature portions of the clamping brackets of one clamping unit curve away from the other clamping unit. This allows for the largest possible gap between the clamping units for receiving the rail tie (over-tie mounting). Due to the curvature portions of the clamping brackets facing away from one another, there is an increased distance between the rail tie and the clamping axis, which allows for generous tool access to the clamping means of the clamping units.

In an alternative preferred embodiment of the sensor arrangement, the distance between the clamping axes is smaller than a distance between the clamp axes of the clamping units, and the clamping units are arranged between two adjacent rail ties. In other words, the clamping brackets of one clamping unit are curved towards the other clamping unit, or the curvature portions of the clamping brackets are curved towards the other clamping unit. This allows the dimension of the quick clamping device in the direction of the longitudinal extent of the rail to be minimized. This enables the quick clamping device to be arranged between the adjacent rail ties (intermediate shaft mounting). As a result of the curvature portions of the clamping brackets facing one another, there is an increased distance between the rail tie and the clamping axis, which allows for generous tool access to the clamping means of the clamping units.

The underlying object addressed is further achieved by using the quick clamping device described above to arrange a rail monitoring element on a rail web of a rail above a rail tie of the rail.

Preferably, parts of the quick clamping device are pre-mounted/fixed on the corresponding rail monitoring element before the rail monitoring element is mounted on the rail. This makes it considerably easier to mount said rail monitoring element and prevents small parts from getting lost.

Further advantages of the invention can be found in the description and the drawings. Likewise, according to the invention, the aforementioned features and those which are to be explained below can each be used individually or together in any desired combinations. The embodiments shown and described are not to be understood as an exhaustive list, but, rather, have an exemplary character for the description of the invention.

### BRIEF DESCRIPTION OF THE DRAWINGS

FIG. 1 is a perspectival view of a first embodiment of a sensor arrangement having a rail, a rail monitoring element, and a quick clamping device.

FIG. 2 is a side view of the sensor arrangement from FIG. 1.

FIG. 3 shows a second embodiment of a sensor arrangement, with a side view of a rail having a low rail profile.

FIG. 4 is a perspectival view of a third embodiment of a sensor arrangement on a rail tie in over-tie mounting.

FIG. 5 is a perspectival view of a quick clamping device having two clamping units, with clamping templates and an insulating sleeve.

FIG. 6 is a side view of a clamping unit of the quick clamping device from FIG. 5 with two clamping brackets and a clamping means and without clamping templates and an insulating sleeve.

FIG. 7 is a perspectival view of an embodiment of a clamping template for a quick clamping device, having a rigid rail abutment and a resilient rail abutment.

FIG. 8 is a perspectival view of another embodiment of a clamping template for a quick clamping device, having two rigid rail abutments and a plurality of securing projections.

### DETAILED DESCRIPTION OF EMBODIMENTS OF THE INVENTION

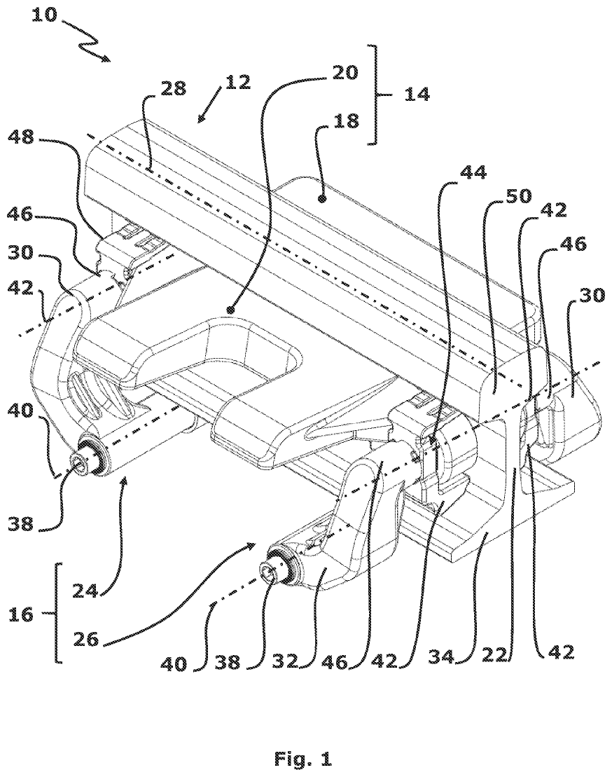

FIG. 1 shows a sensor arrangement 10 having a rail 12, a rail monitoring element 14, and a quick clamping device 16. The rail monitoring element 14 has a first rail contact half 18—here in the form of a transmission unit—and a second rail contact half 20—here in the form of a receiving unit. The first rail contact half 18 and the second rail contact half 20 are arranged on either side of the rail 12 so as to be clamped to a rail web 22 of the rail 12 by means of the same quick clamping device 16.

The quick clamping device 16 has a first clamping unit 24 and a second clamping unit 26. The clamping units 24, 26 are arranged on the rail 12 at a distance from one another along a longitudinal extent 28 of the rail 12. The clamping units 24, 26 are connected to one another via the rail 12 only when mounted.

Each clamping unit 24, 26 has a first clamping bracket 30 and a second clamping bracket 32 (in FIG. 1, only a second clamping bracket 32 is visible). The clamping brackets 30, 32 each engage under a rail foot 34 of the rail 12. In other words, each clamping unit 24, 26 engages around the rail foot 34 by means of the clamping brackets 30, 32.

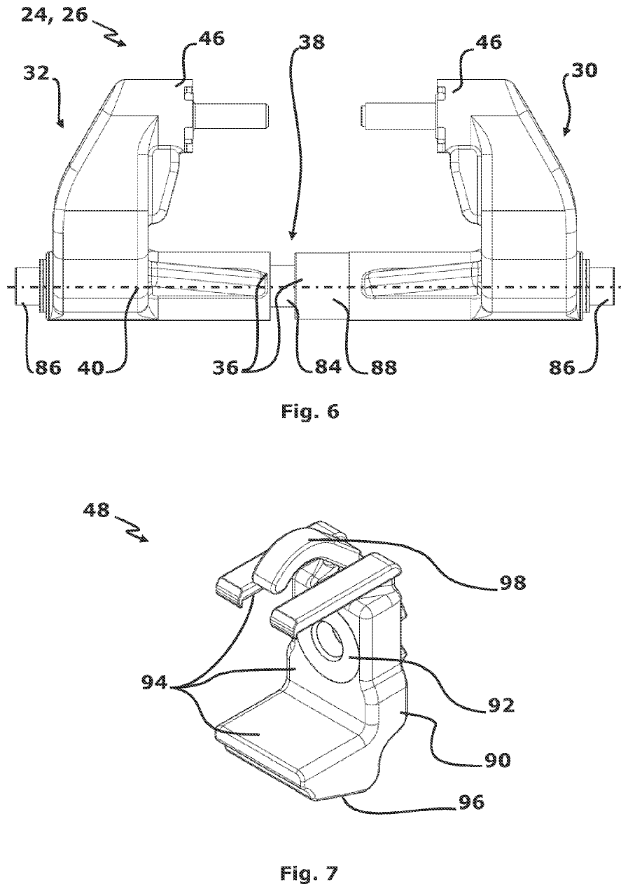

The first clamping bracket 30 and the second clamping bracket 32 of the first clamping unit 24 and the second clamping unit 26 are each connected to one another at a first end 36 (see FIG. 6) by a clamping means 38. The clamping means 38 extend beneath the rail foot 34 and in FIG. 1 have bolt connections, for example. By operating the clamping means 38—here, turning the bolt connections—the distance between the first clamping bracket 30 and the second clamping bracket 32 of each clamping unit 24, 26 along a clamping axis 40 can be changed.

As a result, the distance between the clamping bracket 30 and the clamping bracket 32 along a clamp axis 42 is also changed. In each case, a clamp axis 42 runs through two clamping regions 44 of a clamping unit 24, 26 (for reasons of clarity, only one clamping region 44 is provided with a reference sign). The clamping brackets 30, 32 have the clamping regions 44 at a second end 46. Both the rail monitoring element 14 and the rail web 22 are partially arranged along each clamp axis 42 of the clamping brackets 30, 32. If the distance between the clamping brackets 30, 32 is reduced by the clamping means 38, for example, a clamping force is produced which clamps the rail monitoring element 14 to the rail web 22 along the clamp axes 42. If the distance between the clamping brackets 30, 32 is increased by the clamping means 38, the rail monitoring element 14 can be released from the rail 12.

According to the embodiment shown, the quick clamping device 16 has four clamping templates 48, three clamping templates 48 of which are visible in FIG. 1. A clamping template 48 is attached to each clamping region 44 of a clamping bracket 30, 32. Each clamping template 48 can be designed to partially receive the rail monitoring element 14. In other words, each clamping template 48 can engage around an end region of the rail monitoring element 14, as shown. The clamping templates 44 are adapted to the profile of the rail 12 and arranged between the rail foot 34 and a rail head 50 of the rail 12 without contacting the rail web 22. In other words, the freedom of movement of the clamping templates 14 in the vertical direction is prevented by the rail foot 34 and the rail head 50, or, rather, the clamping templates 14 are clamped between the rail foot 34 and the rail head 50. As a result, a position where the rail monitoring element 14 is clamped to the rail web 22 of the rail 12 can be particularly reliably predetermined.

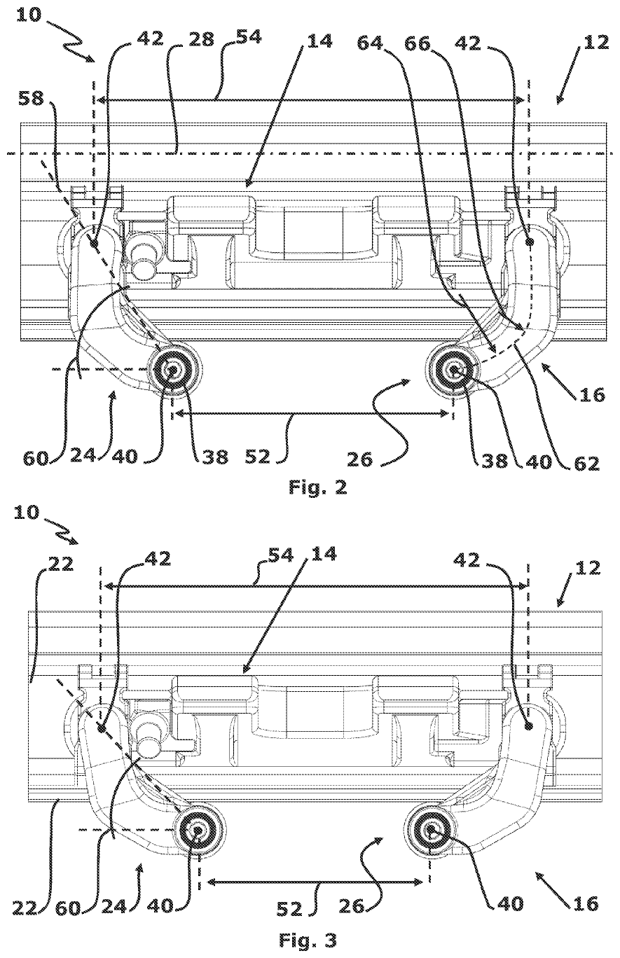

FIG. 2 shows the sensor arrangement 10 from FIG. 1, having the rail monitoring element 14, which is fastened to the rail 12 by means of the quick clamping device 16.

As shown in FIG. 2, the clamping units 24, 26 are arranged at a distance from one another in the longitudinal extent 28 (see FIG. 1) of the rail 12. The clamping axes 40 of the clamping units 24, 26 have a clamping axis distance 52, and the clamp axes 42 of the clamping units 24, 26 have a clamp axis distance 54. According to the embodiment shown, the clamping axis distance 52 is smaller than the clamp axis distance 54. The clamping units 24, 26 are positioned entirely below the rail monitoring element 14. As a result, a dimension of the sensor arrangement 10 in the direction of the longitudinal extent 28 of the rail 12 can be minimized.

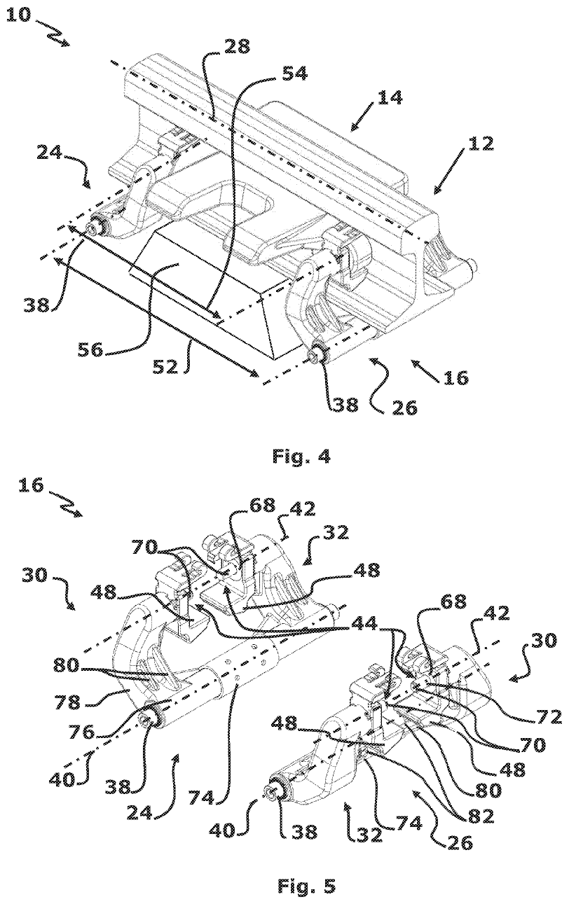

In addition, the sensor arrangement 10 shown can be moved closer to a colliding object on the rail, e.g., a rail tie 56 (see FIG. 4), in the direction of the longitudinal extent 28 of the rail 12, since half the difference between the clamp axis distance 54 and the clamping axis distance 52 can be used for tool access to the clamping means 38.

A straight line 58, which intersects the clamping axis 40 and the clamp axis 42 at a right angle, runs at an angle 60 obliquely to the longitudinal extent 28 of the rail 12 (for reasons of clarity, only one straight line 58 and one angle 60 are provided with a reference sign in FIG. 2). By rotating the clamping units 24, 26 about the corresponding clamping axis 40, the vertical position of the rail monitoring element 14 on the rail 12 can be adjusted. For example, a small angle 60 results in a low vertical position of the rail monitoring element 14 on the rail 12, where the clamping axis distance 52 is small and the clamp axis distance 54 is large in comparison with a medium angle 60. In contrast, a large angle 60 leads, for example, to a high vertical position of the rail monitoring element 14 on the rail 12, where the clamping axis distance 52 is large and the clamp axis distance 54 is small in comparison with a medium angle 60.

The clamping units 24, 26 have a curvature portion 62 which is curved in a normal plane of the clamping axis 40 of the corresponding clamping unit 24, 26. In other words, at least a portion of the curvature portion 62 deviates from the straight line 58. The curvature portion 62 has at least one radius of curvature 64, 66. In the illustrated embodiment of the quick clamping device 16, two radii of curvature 64, 66 are provided with reference signs. The value for the radius of curvature 64 differs from that of the radius of curvature 66.

FIG. 3 is a side view of a second embodiment of the sensor arrangement 10. The sensor arrangement 10 shown in FIG. 3 differs from the embodiment shown in FIGS. 1 and 2 essentially in that the clamping units are arranged at a different angle to the rail.

As shown, the rail 12 has a low rail profile, e.g., a BS80 profile. In other words, the rail web 22 of the rail 12 has a small dimension in the vertical direction, which makes a conventional arrangement of the rail monitoring element 14 difficult.

In this case—as shown—by rotating the clamping units 24, 26, a small angle 60 can be set, thereby reducing the dimension of the quick clamping device 16 in the vertical direction. This allows the rail monitoring element 14 to be fastened to the rail 12 with a low rail profile without changing the components of the quick clamping device 16. In addition, no additional installation space is required below the rail 12, and the clamping units 24, 26 can rest on the rail foot 22.

FIG. 4 shows a further embodiment of the sensor arrangement 10, in which the rail monitoring element 14 is fastened to the rail 12 above a rail tie 56 by means of the quick clamping device 16.

The clamping units 24, 26 of the quick clamping device 16 are arranged on the rail 12 such that the clamping axis distance 52 is greater than the clamp axis distance 54. In other words, the clamping units 24, 26 curve away from the rail monitoring element 14 or the corresponding other clamping unit 24, 26. The dimension of the quick clamping device 16 in the longitudinal extent 28 of the rail 12 is increased, whereby half the difference between the clamping axis distance 52 and the clamp axis distance 54 is available for tool access to the clamping means 38.

FIG. 5 shows a quick clamping device 16 having two clamping units 24, 26. Each clamping unit 24, 26 has a first clamping bracket 30 and a second clamping bracket 32. In the embodiment shown, the clamping unit 24 is substantially identical to the clamping unit 26. In other words, the clamping unit 24 can be rotated about a vertical axis and used as a clamping unit 26.

The first clamping bracket 30 and the second clamping bracket 32 are connected to one another at their first ends 36 (see FIG. 6) by a clamping means 38 and can be moved towards or away from one another along the clamping axis 40 by the clamping means 38. Accordingly, the clamping regions 44 formed at the second ends 46 of the clamping brackets 30, 32 can be moved towards or away from one another along the clamp axis 42 by the clamping means 38.

The clamping regions 44 preferably each have at least one clamping abutment 68 for transferring a clamping force from the clamping bracket 30, 32 to the rail monitoring element 14 (see FIG. 1-4). As shown, the clamping unit 24, 26 has the clamping abutment 68 on the clamping template 48. The clamping abutment 68 can also be formed directly on the clamping bracket 30, 32.

In addition, it can be provided that the clamping unit 24, 26 have a centering projection 70, in particular, on each clamping bracket 30, 32, which protrudes beyond the clamping abutment 68 along the clamp axis 42. Preferably, the centering projection 70 is designed to engage in a complementary recess in the rail monitoring element 14. As a result, the rail monitoring element 14 can be clamped particularly precisely in position by the clamping units 24, 26.

In a particular, generally accepted embodiment, at least one clamping template 48 is movable in at least one direction that is perpendicular to the clamp axis 42, in particular, perpendicular to the longitudinal extent 28 of the rail 12 (see FIGS. 1, 2, and 4). In other words, the clamping template 48 is movable relative to the clamping bracket 78. This allows for angular misalignments caused by elastic deformation of the clamping bracket and shaft during clamping to be compensated for.

The clamping brackets 30 have an insulating means 72 in the form of a plastic sleeve, which electrically insulates the rail monitoring element 14 from the clamping bracket 30 when attached. The insulating means 72 is, as shown, plugged onto the centering projection 70 of the clamping bracket 30.

Each clamping unit 24, 26 has an insulating means 74 in the form of a plastic sleeve covering the first ends 36 (see FIG. 6) of the clamping brackets 30, 32, which electrically insulates the clamping units 24, 26 from the rail foot 34 when the quick clamping device 16 is arranged on a rail 12. Such a covering insulating means 74 can prevent contamination of the intermediate region between the first end 36 of the clamping brackets 30, 32, thereby maintaining functionality. In addition, the insulating means 74 can serve as an abutment surface by which the quick clamping device 16 abuts the rail 12. This means that, together with the clamping regions 44, each clamping unit 24, 26 can be fixed to the rail 12 at three points.

According to the embodiment shown, each clamping bracket 30, 32 can have a cylindrical clamping means portion 76 which engages under the rail foot 34, when the quick clamping device 16 is arranged on the rail 12 and is designed to at least partially receive the clamping means 38. In other words, the clamping means portion 76 is formed predominantly along the clamping means axis 40.

According to the embodiment shown, each clamping bracket 30, 32 can have a load-optimized clamping portion 78 which extends predominantly in a plane orthogonal to the clamping axis 40. A load-optimized structure is understood to mean the design of the clamping portion 78 for the intended load case—here, the bending moment about a vertical axis of the corresponding clamping bracket 30, 32. This effectively prevents over-dimensioning of the clamping brackets 30, 32. Each clamping bracket 30, 32 can, for example, have reinforcing ribs 80 which are formed between the clamping means portion 76 and the clamping portion 78 for the direction-dependent increase in the strength of the clamping brackets 30, 32.

The insulating means 74 can have recesses 82 in the direction of the clamping means axis 40, into which projections—here, two reinforcing ribs 80—of the corresponding clamping brackets 30, 32 of the same clamping unit 24, 26 engage and prevent rotation of the clamping brackets 30, 32 relative to one another. This simplifies the arrangement of the quick clamping device 16 on the rail 12.

FIG. 6 shows the clamping unit 24, 26 of the quick clamping device 16 from FIG. 5 having the first clamping bracket 30 and the second clamping bracket 32, but without the clamping templates 48 and the insulating means 72, 74. The clamping brackets 30, 32 each have the first end 36 and the second end 46. The first ends 36 are connected by the clamping means 38 such that the clamping brackets 30, 32 can be moved towards one another along the clamping axis 40.

For this purpose, the clamping means 38 can, as shown, have a cylindrical sliding body 84 which can be inserted into recesses in the clamping brackets 30, 32 formed at the first ends 36 along the clamping axis 40 and on which sliding body the clamping brackets 30, 32 are arranged so as to move along the clamping axis 40. The cylindrical sliding body 84 can also have threaded recesses at both ends, into each of which a bolt 86 can be screwed. By turning the bolts 86, the maximum distance between the clamping brackets 30, 32 along the clamping axis 40 can be adjusted.

The clamping bracket 30 is substantially mirror-symmetrical to the clamping bracket 32. However, the clamping bracket 30 has a support projection 88 that projects beyond the cylindrical clamping means portion 76 along the clamping axis 40. The support projection 88 is advantageous for adapting the clamping unit 24, 26 with respect to the width of the rail foot 34. Furthermore, the support projection 88 can be used to receive the insulating means 74. The support projection 88 can be formed integrally with one of the clamping brackets 30, 32, or the insulating means 74 or can be loosely arranged on the clamping means 38.

FIG. 7 shows an embodiment of a clamping template 48. The clamping template 48 has a main body 90 with a U-shaped or C-shaped cross-section. The main body 90 can, for example, be made from a plastic by means of plastic injection-molding. The clamping template 48 has a fastening insert 92 arranged in the main body 90. The fastening insert 92 is preferably made of metal. Further preferably, the fastening insert 92 is overmolded with plastic during production of the main body 90 and is non-releasably connected to the main body 90. The clamping template 48 can, for example, be pushed onto the centering projection 70 (see FIG. 5) of the clamping brackets 30, 32. The fastening insert 92 preferably forms the clamping abutment 68 (see FIG. 5).

The inner surfaces 94 of the main body 90 are designed to partially receive the rail monitoring element 14 (see FIGS. 1-4) and adapted to the outer contour of the part of the rail monitoring element 14 to be received.

The clamping template 48 or the main body 90 further has, according to the embodiment shown, a rigid rail abutment 96 and a resilient rail abutment 98. When the clamping template 48 is fastened to the rail 12, the rail abutments 96, 98 rest against the rail foot 34 and the rail head 50. In other words, the rail abutments 96, 98 are adapted to the shape of the rail foot 34 and the shape of the rail head 50. As a result of the resilient rail abutment 98, the clamping template 48 can be used particularly easily on rail profiles that only differ slightly.

The resilient rail abutment 98 can be integrally formed on the clamping template 48.

In a particular embodiment, the resilient rail abutment 98 is made of a metallic material, in particular, spring steel. Typically, the resilient rail abutment 98 is arranged on the clamping template 48 in this case.

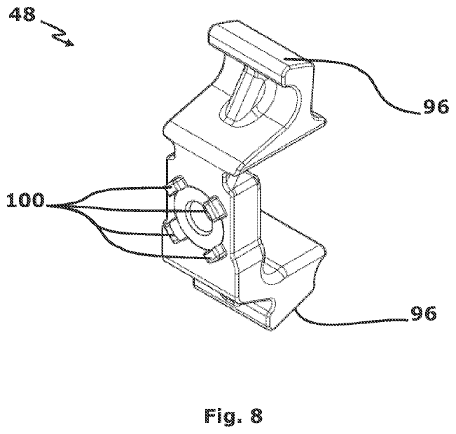

FIG. 8 shows a further embodiment of a clamping template 48. The clamping template 48 shown in FIG. 8 has two rigid rail abutments 96.

In addition, the clamping template 48 has a plurality of—here, four—securing projections 100 formed on the main body 90, which, when the clamping template 48 is arranged on a clamping bracket 30, 32, engage in complementary recesses in the clamping bracket 30, 32 and form a mechanism that prevents the clamping template 48 from rotating relative to the clamping bracket 30, 32.

In a particular embodiment, it can be provided that the second end 46 of at least one clamping bracket 30, 32 has at least one securing projection 100 which engages in a recess in the clamping template 48 in order to provide protection against rotation. Preferably, the recess is designed as a slot.

### LIST OF REFERENCE SIGNS

10 sensor arrangement;
12 rail;
14 rail monitoring element;
16 quick clamping device;
18 first rail contact half;
20 second rail contact half;
22 rail web of the rail 12;
24 first clamping unit;
26 second clamping unit;
28 longitudinal extent of the rail 12;
30 first clamping bracket;
32 second clamping bracket;
34 rail foot of the rail 12;
36 first end of the clamping brackets 30, 32;
38 clamping means;
40 clamping axis;
42 clamp axis;
44 clamping region;
46 second end of the clamping brackets 30, 32;
48 clamping template;
50 rail head of the rail 12;
52 clamping axis distance;
54 clamp axis distance;
56 rail tie;
58 straight line;
60 angle;
62 curvature portion;
64 radius of the curvature portion 62;
66 radius of the curvature portion 62;
68 clamping abutment;
70 centering projection;
72 insulating means;
74 insulating means;
76 clamping means portion;
78 clamping portion;
80 reinforcing rib;
82 recesses in the insulating means 74;
84 sliding body;
86 bolt;
88 support projection;
90 main body of the clamping template 48;
92 fastening insert of the clamping template 48;
94 inner surface of the clamping template 48;
96 rigid rail abutment;
98 resilient rail abutment;
100 safety projections.

### BIBLIOGRAPHY

EP 3 420 134 B1 (Siemens Mobility GmbH)

What is claimed is:

1. A quick clamping device for fastening at least one rail monitoring element to a rail, having two clamping units;
wherein the clamping units each have two clamping brackets and a clamping means;
wherein the two clamping brackets are configured to each be connected at a first end by the clamping means along a clamping axis where the clamping means engages under a rail foot of the rail when said foot is fastened to the rail, and
wherein the clamping brackets at a second end each have a clamping region which is designed for force-fit arrangement on a rail web of the rail and/or the rail monitoring element;
wherein the clamping units can be arranged on the rail as separate elements at a distance from one another along a longitudinal extent of the rail;
and the clamping brackets each have at least one curvature portion which is curved in a plane orthogonal to the clamping axis.

2. The quick clamping device according to claim 1, wherein the clamping brackets of a clamping unit are symmetrical with respect to a plane orthogonal to the clamping axis.

3. The quick clamping device according to claim 1, wherein the clamping means is designed as a bolt connection, wherein the bolt connection passes through the clamping brackets of a clamping unit.

4. The quick clamping device according to claim 1, wherein the clamping brackets are made of a metallic material.

5. The quick clamping device according to claim 1, wherein the clamping brackets are made of aluminum.

6. The quick clamping device according to claim 1, wherein the clamping units have at least one insulating means which is designed to electrically insulate the quick clamping device from the rail, wherein the insulating means is preferably designed as an insulating sleeve.

7. The quick clamping device according to claim 6, wherein the clamping units have an electrical insulating means at the first end of each clamping bracket and at least at a second end of one of the clamping brackets, wherein the insulating means are preferably designed as insulating sleeves.

8. The quick clamping device according to claim 1, wherein the clamping units each have at least one clamping template which is designed for positioning the clamping brackets on the rail web.

9. The quick clamping device according to claim 8, wherein a clamping template is fastened to the second end of a clamping bracket in each case, wherein the clamping templates can be plugged onto the clamping region of the clamping brackets.

10. The quick clamping device according to claim 8, wherein the clamping templates have at least one element, being a securing projection or a securing recess, which, in conjunction with the clamping bracket, form-lockingly limits rotation of the clamping template relative to the clamping bracket.

11. The quick clamping device according to claim 8, wherein the clamping template is designed to at least partially receive the rail monitoring element.

12. A sensor arrangement having the rail, the quick clamping device according to claim 1, and the rail monitoring element mounted on the rail by means of the quick clamping device,
wherein the rail web of the rail and the rail monitoring element are at least partially arranged between the clamping regions of the clamping brackets of two clamping units of the quick clamping device;
wherein the clamping units each engage around the rail foot of the rail; and
wherein, along a clamp axis running through the clamping regions, a clamping force is produced between the corresponding clamping unit, the rail monitoring element, and the rail web.

13. The sensor arrangement according to claim 12, wherein a clamping axis distance between the clamping axes is greater than a clamp axis distance between the clamp axes of the clamping units, and a rail tie is arranged between the clamping units.

14. The sensor arrangement according to claim 12, wherein the clamping axis distance between the clamping axes is smaller than the clamp axis distance between the clamp axes of the clamping units, and the clamping units are arranged between two rail ties.

15. The use of the quick clamping device according to claim 1 for arranging the rail monitoring element on the rail web of the rail above a rail tie of the rail.

16. The use according to claim 15, wherein the parts of the quick clamping device are pre-mounted/fixed on the corresponding rail monitoring element before the rail monitoring element is mounted on the rail.
